(19) United States
(12) Patent Application Publication
(10) Pub. No.: US 2024/0425082 A1
(43) Pub. Date: Dec. 26, 2024

(54) Vehicle Control Apparatus And Method Thereof

(71) Applicants: Hyundai Motor Company, Seoul (KR); Kia Corporation, Seoul (KR)

(72) Inventor: Dae Hyun Kim, Seoul (KR)

(21) Appl. No.: 18/532,355

(22) Filed: Dec. 7, 2023

(30) Foreign Application Priority Data
Jun. 20, 2023 (KR) 10-2023-0079180

(51) Int. Cl. B60W 60/00; B60W 50/02; G06F 8/65; G06F 11/14; G06F 21/57

(52) U.S. Cl. CPC B60W 60/00188; B60W 50/0205; B60W 50/0225; B60W 60/0053; G06F 8/65; G06F 11/1433; G06F 21/572; B60W 2050/0095; B60W 2556/45; G06F 2221/033

(57) ABSTRACT

A vehicle control apparatus and a method thereof are provided. The vehicle control apparatus includes a processor and a communication circuit. The vehicle control apparatus, in a first mode in which the autonomous vehicle is operated in an autonomous driving level greater than or equal to a specified level, transmits, to a first external device based on detecting an unauthorized modification to software of the autonomous vehicle by a second external device different from the first external device, a signal indicating the unauthorized modification to the software, and performs at least one of changing to a second mode that allows a passenger of the autonomous vehicle to control the autonomous vehicle, stopping operation of the autonomous vehicle for a specified time duration, or limiting a function executed by the autonomous vehicle. The vehicle control apparatus further restores the software based on receiving first data for restoring the software.

### CROSS-REFERENCE TO RELATED APPLICATION

This application claims the benefit of priority to Korean Patent Application No. 10-2023-0079180, filed in the Korean Intellectual Property Office on Jun. 20, 2023, the entire contents of which are incorporated herein by reference.

### TECHNICAL FIELD

The present disclosure relates to a vehicle control apparatus, a system including the same, and a method thereof, and more particularly, relates to technologies of recovering software modified without authorization.

### BACKGROUND

With the development of vehicle technology, autonomous driving has enabled a vehicle to operate on its own. An autonomous vehicle may include an autonomous driving system for autonomous driving, which may be operated based on a hardware component or a software component included in the autonomous driving system of the autonomous vehicle.

For example, as the autonomous vehicle recognizes a road environment (or an environment around the autonomous vehicle) on its own, determines a driving situation, and controls driving along a planned driving route, an autonomous driving control device for allowing the autonomous vehicle to automatically travel to a destination without the intervention of the driver is provided and research on this technology is actively progressing.

While such an autonomous vehicle is operated, software included in the autonomous vehicle may be changed by an external electronic device. For example, software may be changed by an external electronic device which is not allowed access or the external electronic device may control the autonomous vehicle. Various methods for preventing it or recovering the changed software have been studied.

### SUMMARY

The present disclosure has been made to solve the above-mentioned problems occurring in the prior art while advantages achieved by the prior art are maintained intact.

An aspect of the present disclosure provides a vehicle control apparatus for recovering software changed by a second external electronic device different from a first external electronic device including a server and a method thereof.

Another aspect of the present disclosure provides a vehicle control apparatus for restoring a system hacked by the second external electronic device, a system including the same, and a method thereof.

Another aspect of the present disclosure provides a vehicle control apparatus for performing a different operation depending on a hacked controller, when one of an important controller, an autonomous driving controller, or a general controller is hacked, and a method thereof.

The technical problems to be solved by the present disclosure are not limited to the aforementioned problems, and any other technical problems not mentioned herein will be clearly understood from the following description by those skilled in the art to which the present disclosure pertains.

According to one or more example embodiments of the present disclosure, a vehicle control apparatus may include: a communication circuit, a processor configured to control an autonomous vehicle, and memory. The memory may store instructions that, when executed by the processor, may cause the vehicle control apparatus to: in a first mode in which the autonomous vehicle is operated in an autonomous driving level greater than or equal to a specified level, transmit, to a first external device via the communication circuit and based on detecting an unauthorized modification to software of the autonomous vehicle by a second external device different from the first external device, a signal indicating the unauthorized modification to the software. The first external device may be a server. The instructions, when executed by the processor, may further cause the vehicle control apparatus to perform, based on the transmission of the signal, at least one of: changing from the first mode to a second mode that allows a passenger of the autonomous vehicle to control the autonomous vehicle, stopping operation of the autonomous vehicle for a specified time duration, or limiting a function executed by the autonomous vehicle. The instructions, when executed by the processor, may further cause the vehicle control apparatus to restore the software, based on receiving, from the first external device, first data for restoring the software.

The instructions, when executed by the processor, may cause the vehicle control apparatus to: stop the operation of the autonomous vehicle for the specified time duration or limit the function, based on identifying that the unauthorized modification to the software is associated with at least one of: a powertrain of the autonomous vehicle, a body of the autonomous vehicle, a chassis of the autonomous vehicle, or a communication gateway of the autonomous vehicle. The function may be associated with the unauthorized modification.

The instructions, when executed by the processor, may cause the vehicle control apparatus to: change from the first mode to the second mode, based on identifying that the unauthorized modification to the software is associated with at least one of: an autonomous driving feature of the autonomous vehicle or an information feature of the autonomous vehicle.

The first data may include the software before being modified by the second external device.

The instructions, when executed by the processor may further cause the vehicle control apparatus to: perform a software test, based on the software being restored; and transmit, to the first external device via the communication circuit and based on a result of the software test being normal, a signal indicating the result.

The software test may include at least one of software verification or software validation.

The instructions, when executed by the processor, may further cause the vehicle control apparatus to: receive, from the first external device via the communication circuit, second data; and update, based on the second data, the restored software.

The instructions, when executed by the processor, may cause the vehicle control apparatus to: update the restored software after the autonomous vehicle is stopped.

The instructions, when executed by the processor, may cause the vehicle control apparatus to: restore the software using the first data, based on a speed of the autonomous vehicle being less than or equal to a specified speed.

The instructions, when executed by the processor, may cause the vehicle control apparatus to: restore the software based on receiving, via an input device of the autonomous vehicle, a request to restore the software.

According to one or more example embodiments of the present disclosure, a vehicle control method may include: in a first mode in which an autonomous vehicle is operated in an autonomous driving level greater than or equal to a specified level, transmitting, to a first external device and based on detecting an unauthorized modification to software of the autonomous vehicle of by a second external device different from the first external device, a signal indicating the unauthorized modification to the software. The first external device may include a server. The vehicle control method may further include: performing, based on the transmitting of the signal, at least one of: changing from the first mode to a second mode that allows a passenger of the autonomous vehicle to control the autonomous vehicle, stopping operation of the autonomous vehicle for a specified time duration, or limiting a function executed by the autonomous vehicle; and restoring the software, based on receiving, from the first external device, first data for restoring the software.

Stopping the operation or limiting of the function may be based on identifying that the unauthorized modification to the software is associated with at least one of: a powertrain of the autonomous vehicle, a body of the autonomous vehicle, a chassis of the autonomous vehicle, or a communication gateway of the autonomous vehicle.

Changing from the first mode to the second mode may be based on identifying that the unauthorized modification to the software is associated with at least one of: an autonomous driving feature of the autonomous vehicle or information feature of the autonomous vehicle.

The first data may include the software before being modified by the second external device.

The vehicle control method may further include: performing a software test, based on the software being restored; and transmitting, to the first external device and based on a result of the software test being normal, a signal indicating the result.

The software test may include at least one of software verification or software validation.

The vehicle control method may further include: receiving, from the first external device, second data; and updating, based on the second data, the restored software.

Updating the restored software may include: updating the restored software after the autonomous vehicle is stopped.

The vehicle control method may further include: restoring the software using the first data, based on a speed of the autonomous vehicle being less than or equal to a specified speed.

Restoring the software may include: restoring the software based on receiving, via an input device of the autonomous vehicle, a request to restore the software.

### BRIEF DESCRIPTION OF THE DRAWINGS

The above and other objects, features and advantages of the present disclosure will be more apparent from the following detailed description taken in conjunction with the accompanying drawings:

FIG. 1 illustrates an example of a block diagram of a vehicle control apparatus;

FIG. 2 illustrates a table for describing an autonomous driving level of an autonomous vehicle including a vehicle control apparatus;

FIG. 3 illustrates an example of a flowchart about an operation of a vehicle control apparatus;

FIG. 4 illustrates an example of a flowchart about an operation of a vehicle control apparatus;

FIG. 5 illustrates an example of a flowchart about an operation of a vehicle control apparatus;

FIG. 6 illustrates an example of a flowchart about an operation of a vehicle control apparatus; and

FIG. 7 illustrates a computing system including a vehicle control apparatus.

### DETAILED DESCRIPTION

Hereinafter, one or more example embodiments of the present disclosure will be described in detail with reference to the exemplary drawings. In the drawings, the same reference numerals will be used throughout to designate the same or equivalent elements. In addition, a detailed description of well-known features or functions will be ruled out in order not to unnecessarily obscure the gist of the present disclosure.

In describing elements of example embodiment(s) of the present disclosure, the terms first, second, A, B, (a), (b), and the like may be used herein. These terms are only used to distinguish one element from another element, but do not limit the corresponding elements irrespective of the order or priority of the corresponding elements. Furthermore, unless otherwise defined, all terms including technical and scientific terms used herein are to be interpreted as is customary in the art to which this disclosure belongs. It will be understood that terms used herein should be interpreted as having a meaning that is consistent with their meaning in the context of this disclosure and the relevant art and will not be interpreted in an idealized or overly formal sense unless expressly so defined herein.

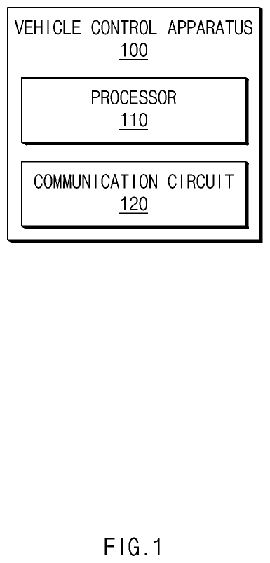

Hereinafter, example embodiment(s) of the present disclosure will be described in detail with reference to FIGS. 1 to 7.

FIG. 1 illustrates an example of a block diagram of a vehicle control apparatus.

Referring to FIG. 1, a vehicle control apparatus 100 may be implemented inside or outside a vehicle, and some of components included in the vehicle control apparatus 100 may be implemented inside or outside the vehicle. In this case, the vehicle control apparatus 100 may be integrally configured with control units in the vehicle or may be implemented as a separate device to be connected with the control units of the vehicle by a separate connection means. For example, the vehicle control apparatus 100 may further include components which are not shown in FIG. 1.

The vehicle control apparatus 100 may include a processor 110 and a communication circuit 120. The processor 110 and the communication circuit 120 may be electronically or operably coupled with each other by an electronical component including a communication bus.

Hereinafter, that pieces of hardware are operably coupled with each other may include a direct connection or an indirectly connection between the pieces of hardware is established in a wired or wireless manner, such that second hardware is controlled by first hardware among the pieces of hardware. The different blocks are illustrated, but the present disclosure is not limited thereto. Some of the pieces of hardware of FIG. 1 may be included in a single integrated circuit such as a system on a chip (SoC). Types of the pieces of hardware included in the vehicle control apparatus 100 or the number of the pieces of hardware are limited to those shown in FIG. 1. For example, the vehicle control apparatus 100 may include some of the pieces of hardware shown in FIG. 1.

The processor 110 of the vehicle control apparatus 100 may include hardware for processing data based on one or more instructions. The hardware for processing the data may include the processor 110. For example, the hardware for processing the data may include an arithmetic and logic unit (ALU), a floating point unit (FPU), a field programmable gate array (FPGA), a central processing unit (CPU), and/or an application processor (AP). The processor 110 may have a structure of a single-core processor or may have a structure of a multi-core processor including a dual core, a quad-core, a hexa-core, or an octa-core.

The communication circuit 120 of the vehicle control apparatus 100 may include a hardware component for supporting transmission or reception of a signal between the vehicle control apparatus 100 and an external electronic device. For example, the communication circuit 120 may include at least one of a modem, an antenna, or an optic/electronic (O/E) converter, or any combination thereof.

For example, the communication circuit 120 may support transmission or reception of a signal based on various types of protocols including an Ethernet, a local area network (LAN), a wide area network (WAN), wireless-fidelity (Wi-Fi), Bluetooth, Bluetooth low energy (BLE), ZigBee, long term evolution (LTE), and 5th generation new radio (5G NR).

The vehicle control apparatus 100 may include the processor 110 for controlling an autonomous vehicle. For example, the processor 110 may establish a communication link with a first external electronic device including a server. The processor 110 may store a program (or a system) for controlling the autonomous vehicle in a memory (not shown), based on receiving software including a specified type or a specified file from the first external electronic device.

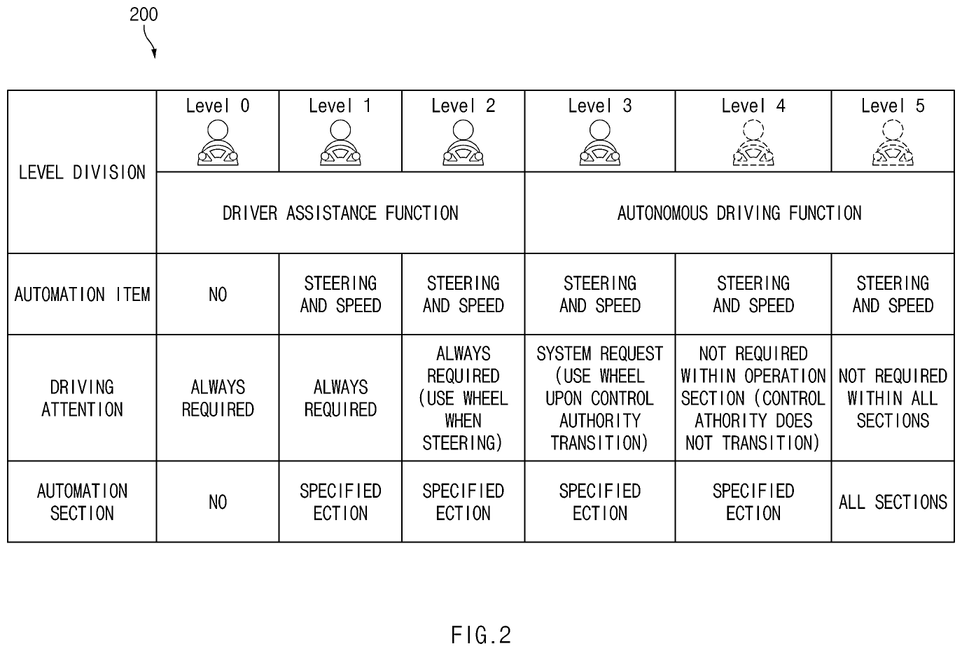

The processor 110 may identify a first mode in which the autonomous vehicle is operated in an autonomous driving level which is greater than or equal to a specified level. For example, the first mode may be referred to as a system mode. For example, the processor 110 may cause a passenger to operate the autonomous vehicle based on that the autonomous driving level is Level 0 to Level 2. For example, the processor 110 may control and operate the autonomous vehicle along a specified route, based on that the autonomous driving level is Level 3 to Level 5. When the autonomous driving level is greater than or equal to Level 3, the processor 110 may identify that the autonomous vehicle is operated in the first mode. A description associated with the autonomous driving level will be given below with reference to FIG. 2.

The processor 110 may identify the first mode in which the autonomous vehicle is operated in the autonomous driving level which is greater than or equal to the specified level (e.g., Level 3). In the first mode in which the autonomous vehicle is operated in the autonomous driving level which is greater than or equal to the specified level, the processor 110 may identify a change in software (e.g., an unauthorized modification to the software) by a second external electronic device different from the first external electronic device including the server.

For example, the processor 110 may identify that at least a part of software is changed by the second external electronic device which is not allowed access to the vehicle control apparatus 100. That at least a part of software is changed (e.g., modified without authorization) by the second external electronic device which is not allowed access to the vehicle control apparatus 100 may be referred to as hacking.

The processor 110 may transmit a signal for providing a notification of the change in software to the first external electronic device through the communication circuit 120, based on identifying that the change in software by the second external electronic device. The processor 110 may perform a specified operation, based on at least one of the transmission of the signal for providing the notification of the change in software or the change in software, or any combination thereof.

For example, the processor 110 may change from the first mode to a second mode in which it is possible for the passenger to control the autonomous vehicle, based on at least one of the transmission of the signal for providing the notification of the change in software or the change in software, or any combination thereof. For example, the second image may include a case where the autonomous driving level is Level 0 to Level 2.

For example, the processor 110 may stop the operation of the autonomous vehicle during at least a specified time or more, based on at least one of the transmission of the signal for providing the notification of the change in software or the change in software, or any combination thereof.

For example, the processor 110 may limit a function executed by the autonomous vehicle, based on at least one of the transmission of the signal for providing the notification of the change in software or the change in software, or any combination thereof. For example, the operation of limiting the function executed by the autonomous vehicle may include an operation of stopping controlling hardware associated with the software changed by the second external electronic device.

As described above, the processor 110 may perform at least one of changing from the first mode to the second mode in which it is possible for the passenger to control the autonomous vehicle, stopping the operation of the autonomous vehicle during the at least a specified time or more, or limiting the function executed by the autonomous vehicle, or any combination thereof, based on at least one of the transmission of the signal for providing the notification of the change in software or the change in software, or any combination thereof.

The processor 110 may identify that software is changed. For example, the processor 110 may identify a change in software including a powertrain domain included in the autonomous vehicle including the vehicle control apparatus 100, a body domain included in the autonomous vehicle including the vehicle control apparatus 100, a chassis domain included in the autonomous vehicle including the vehicle control apparatus 100, a gateway (e.g., a communication gateway) included in the autonomous vehicle including the vehicle control apparatus 100, an autonomous driving domain included in the autonomous vehicle including the vehicle control apparatus 100, or an info domain included in the autonomous vehicle including the vehicle control apparatus 100, or any combination thereof.

For example, the powertrain domain may be associated with at least one of an engine of the autonomous vehicle, a transmission of the autonomous vehicle, or a powertrain system of the autonomous vehicle, or any combination thereof. For example, the body domain may be associated with an airbag system of the autonomous vehicle. For example, the chassis domain may be associated with at least one of a steer system of the autonomous vehicle or a brake system of the autonomous vehicle, or any combination thereof. For example, the autonomous driving domain may be associated with an autonomous driving system including an advanced driver assistance system (ADAS). For example, the info domain may be associated with at least one of a communication control system or an infotainment system, or any combination thereof.

For example, infotainment is a portmanteau of “information” and “entertainment”, which may include providing a passenger with at least one of driving-related information of the autonomous vehicle or enjoyable things of the autonomous vehicle, or anything thereof.

For example, the processor 110 may stop the operation of the autonomous vehicle during at least a specified time or more or may limit a function associated with the changed software, based on identifying the change in software including at least one of the powertrain domain included in the autonomous vehicle, the body domain included in the autonomous vehicle, the chassis domain included in the autonomous vehicle, or the gateway (e.g., a communication gateway) included in the autonomous vehicle, or any combination thereof.

For example, the processor 110 may change from the first mode to the second mode in which it is possible for a user to control the autonomous vehicle, based on identifying the change in software including the at least one of the autonomous driving domain included in the autonomous vehicle or the info domain included in the autonomous vehicle, or any combination thereof.

The processor 110 may receive first data for recovering (e.g., restoring) the changed software from the first external electronic device, based on performing at least one of changing from the first mode to the second mode in which it is possible for the passenger to control the autonomous vehicle, stopping the operation of the autonomous vehicle during the at least a specified time or more, or limiting the function executed by the autonomous vehicle, or any combination thereof. For example, the first data may include the software before being changed by the second external electronic device.

The processor 110 may recover (e.g., restore) the changed software in response to receiving the first data for recovering the changed software. For example, the operation of recovering of the changed software may include an operation of overwriting the first data to the changed software.

The processor 110 may recover (e.g., restore) the changed software, using a software installation file stored in the memory. For example, the processor 110 may execute a software installation file associated with the changed software to reinstall the changed software. The processor 110 may recover the changed software, based on reinstalling the changed software.

The processor 110 may identify a speed of the autonomous vehicle. For example, the processor 110 may recover the software using the first data transmitted from the first external electronic device, based on that the speed of the autonomous vehicle is less than or equal to a specified speed.

The processor 110 may perform a software test, based on recovering the changed software. For example, the processor 110 may perform at least one of software verification or software validation, or any combination thereof. For example, the software test may include at least one of software verification or software validation, or any combination thereof.

The processor 110 may receive second data associated with updating the recovered software from the first external electronic device through the communication circuit 120. The processor 110 may update the recovered software, based on receiving the second data. For example, the processor 110 may update software to block the second external electronic device which attempts unauthorized access.

The processor 110 may update software in a specified state. For example, the processor 110 may update the recovered software using the second data, in a state where the autonomous vehicle is stopped.

The processor 110 may update the recovered software using the second data, in a state where the autonomous vehicle is operated at a specified speed or less.

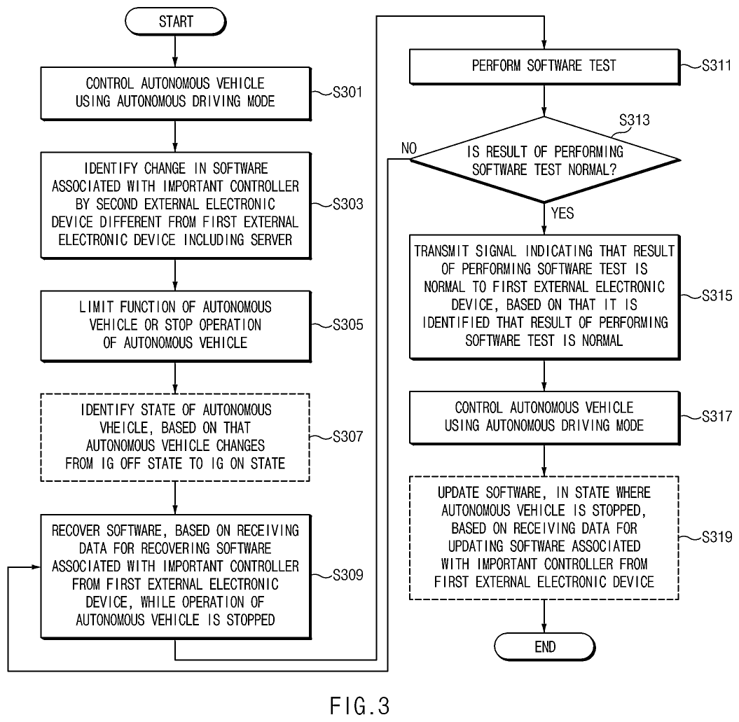

For example, the processor 110 may update the software in the specified state depending on the changed software. A description associated with the operation of updating the software in the specified state depending on the changed software will be given below with reference to FIGS. 3 to 5.

As described above, the processor 110 of the vehicle control apparatus 100 may identify that the software is changed by the second external electronic device through the unauthorized access. The processor 110 may block access of the second external electronic device, based on identifying the software changed by the second external electronic device, and may recover the changed software. The processor 110 may maintain the operation of the autonomous vehicle by blocking the access of the second external electronic device and recovering the changed software.

FIG. 2 illustrates a table for describing an autonomous driving level of an autonomous vehicle including a vehicle control apparatus.

Table 200 of FIG. 2 may include a table for describing an autonomous driving level of an autonomous vehicle. Table 200 is for describing an example associated with the autonomous driving level and is not limited to those shown in Table 200.

Referring to FIG. 2, the autonomous driving level may be divided into Level 0 to Level 5. For example, a vehicle having an autonomous driving level which is Level 0 to Level 2 may provide a driver assistance function. For example, a vehicle having an autonomous driving level which is Level 3 to Level 5 may including an autonomous driving function.

For example, the vehicle having an autonomous driving level which is Level 0 m may fail to have an item controlled by the vehicle control apparatus. For example, the vehicle having the autonomous driving level which is Level 0 may require driving attention at all times because there is no automation item, when the driver operates the vehicle. For example, the driving attention may include controlling the steering of the vehicle using a steering wheel included in the vehicle and allowing the driver to control a speed of the vehicle.

For example, the vehicle having the autonomous driving level which is Level 1 may be controlled in steering or speed in a specified section by the vehicle control apparatus. For example, the vehicle having the autonomous driving level which is Level 1 may require driving attention at all times, when the driver operates the vehicle. The vehicle having the autonomous driving level which is Level 1 may require driving attention of the driver at all times, because steering or speed is automatically controlled in a specified section.

For example, the vehicle having the autonomous driving level which is Level 2 may be controlled in steering and speed of the vehicle in a specified interval by the vehicle control apparatus. The vehicle having the autonomous driving level which is Level 2 may require driving attention of the driver at all times and may use a steering wheel when steering.

For example, the vehicle having the autonomous driving level which is Level 3 may be controlled in steering and speed of the vehicle in a specified interval by the vehicle control apparatus. The vehicle having the autonomous driving level which is Level 3 may use the steering wheel only when control authority changes from the vehicle control apparatus to the driver.

The vehicle having the autonomous driving level which is Level 3 may change control authority from the vehicle control apparatus to the driver based on identifying a specified event. For example, the specified event may include the occurrence of a fallback. For example, the case where the vehicle control apparatus has the control authority of the vehicle may be referred to as a first mode, and the case where the driver has the control authority of the vehicle may be referred to as a second mode.

For example, the vehicle having the autonomous driving level which is Level 4 may be controlled in steering and speed of the vehicle in a specified section by the vehicle control apparatus. The vehicle having the autonomous driving level which is Level 4 may not require driving attention in the specified section. For example, the vehicle having the autonomous driving level which is Level 4 may fail to change control authority although a specified event occurs in the specified section.

For example, the vehicle having an autonomous driving level which is level 5 m may fail to require driving attention, while the vehicle is operating. The vehicle having the autonomous driving level which is Level 5 may fail to require driving attention of the passenger, because steering and speed of the vehicle are controlled by the autonomous driving apparatus in all sections.

A processor (e.g., a processor 110 of FIG. 1) of a vehicle control apparatus (e.g., a vehicle control apparatus 100 of FIG. 1) may identify a change in software by a second external electronic device different from a first external electronic device, in the first mode where the autonomous vehicle is operated in an autonomous driving level which is greater than or equal to a specified level (e.g., Level 3).

The processor may transmit a signal for providing a notification of the change in software to the first external electronic device (e.g., a server) through a communication circuit (e.g., a communication circuit 120 of FIG. 1), based on identifying the change in software.

As described above, the processor may perform at least one of changing from the first mode to the second mode in which it is possible for a passenger to control the autonomous vehicle, stopping the operation of the autonomous vehicle during at least a specified time or more, or limiting a function executed by the autonomous vehicle, or any combination thereof, based on at least one of the signal for providing the notification of the change in software or the change in software, or any combination thereof.

As described above, the vehicle control apparatus may help the autonomous vehicle to safely drive by stopping the operation of the autonomous vehicle or changing from the first mode to the second mode, based on identifying the software changed by the second external electronic device while the autonomous vehicle is operated in the autonomous driving level which is greater than or equal to the specified level.

FIG. 3 illustrates an example of a flowchart about an operation of a vehicle control apparatus.

Hereinafter, it is assumed that a vehicle control apparatus 100 of FIG. 1 performs a process of FIG. 3. Furthermore, in a description of FIG. 3, an operation described as being performed by a processor of a vehicle control apparatus may be understood as being controlled by a processor 110 of a vehicle control apparatus 100.

Respective operations of FIG. 3 may be sequentially performed, but are not necessarily sequentially performed. For example, an order of the respective operations may be changed, and at least two operations may be performed in parallel.

Referring to FIG. 3, in S301, the processor of the vehicle control apparatus may control an autonomous vehicle using an autonomous driving mode. For example, the autonomous driving mode may include a case where the autonomous driving level is greater than or equal to Level 3. For example, when the autonomous driving level is greater than or equal to Level 3, the processor may control a speed of the autonomous vehicle and steering of the autonomous vehicle to operate the autonomous vehicle.

In S303, the processor may identify a change in software associated with an important controller by a second external electronic device different from a first external electronic device including a server.

For example, the change in software associated with the important controller by the second external electronic device may include a case where at least a part of software is changed by the second external electronic device which is not allowed access to the vehicle control apparatus.

For example, that the software is changed by the second external electronic device may include that at least a portion of an instruction included in the software or a code included in the software, any combination thereof is changed. However, the present disclosure is not limited thereto.

For example, the important controller may include at least one of a powertrain domain, a body domain, a chassis domain, or a gateway, or any combination thereof.

For example, the powertrain domain may include an engine controller for controlling at least one of a motor or a fuel cell, or any combination thereof. For example, the powertrain domain may include a transmission controller for controlling a gear shift included in the autonomous vehicle. For example, the powertrain domain may include a powertrain system. As described above, the powertrain domain may include at least one of the engine controller, the transmission controller, or the powertrain system, or any combination thereof.

For example, the body domain may include an airbag system for controlling an airbag.

For example, the chassis domain may include a steering system for controlling the steering of the autonomous vehicle. For example, the chassis domain may include a brake system for controlling the brake of the autonomous vehicle. As described above, the chassis domain may include at least one of the steering system or the brake system, or any combination thereof.

In S305, the processor may limit a function of the autonomous vehicle or may stop the operation of the autonomous vehicle. For example, the processor may limit a function of the autonomous vehicle or may stop the operation of the autonomous vehicle during at least a specified time or more, based on identifying the change in software associated with the important controller by the second external electronic device different from the first external electronic device.

For example, the processor may stop the operation of the autonomous vehicle, based on identifying that the at least a part of the software associated with the powertrain domain is changed.

For example, the processor may limit a function (e.g., an airbag control function) associated with the body domain, based on that the at least a part of the software associated with the body domain is changed.

For example, the processor may stop the operation of the autonomous vehicle, based on that the at least a part of the software associated with the chassis domain is changed.

For example, the processor may stop the operation of the autonomous vehicle, based on that the at least a part of the software associated with the gateway (e.g., a communication gateway) is changed.

In S307, the processor may identify that the autonomous vehicle changes from an IG OFF state to an IG ON state. The processor may verify a state of the autonomous vehicle, based on that the autonomous vehicle changes from the IG OFF state to the IG ON state. For example, verifying the state of the autonomous vehicle may include an operation of identifying whether the autonomous vehicle is able to be operated in an autonomous driving level which is greater than or equal to a specified level. The S307 may be omitted.

For example, the IG OFF state may include a state where all power sources included in the autonomous vehicle are cut off. For example, the IG OFF state may include a state where power is not supplied to at least one of a drive motor included in the autonomous vehicle or an engine included in the autonomous vehicle, or any combination thereof and where power is supplied to at least some of the hardware components included in the autonomous vehicle.

In S309, the processor may receive data for recovering (e.g., restoring) software associated with the important controller from the first external electronic device, while the operation of the autonomous vehicle is stopped. The processor may recover the software, based on receiving the data for recovering the software associated with the important controller from the first external electronic device, while the operation of the autonomous vehicle is stopped.

For example, the processor may receive data including the software before the changed software is changed to recover the changed software from the first external electronic device. The processor may recover the software, based on receiving the data including the software before the changed software is changed from the first external electronic device.

The processor may recover the software associated with the important controller in response to a signal for requesting to recover the software associated with the important controller, which is received using an input device (e.g., a display including a touch panel) included in the autonomous vehicle.

In S311, the processor may perform a software test. For example, the software test may include at least one of software verification or software validation, or any combination thereof.

For example, the software verification may include identifying whether it is able to operate the autonomous vehicle in a normal state using software. For example, the software validation may include identifying whether the software reflects a requirement of a passenger.

In S313, the processor may identify whether the result of performing the software test is normal. The processor may perform a different operation depending on whether the result of performing the software test is normal.

When the result of performing the software test is normal (YES of S313), in S315, the processor may transmit the result of performing the software test to the first external electronic device. The processor may transmit a signal indicating that the result of performing the software test is normal to the first external electronic device, based on that it is identified that the result of performing the software test is normal.

For example, the processor may transmit a signal indicating that the result of performing the software verification is normal to the first external electronic device, based on that it is identified that the result of performing the software verification is normal.

When the result of performing the software test is not normal (NO of S315), the processor may perform S309. The processor may transmit a signal for requesting data for recovering software to the first external electronic device, based on that it is identified that the result of performing the software test is not normal.

In S317, the processor may control the autonomous vehicle using the autonomous driving mode. For example, the processor may control the autonomous vehicle using the autonomous driving mode, based on identifying that the changed software is recovered and that the result of performing the software test is normal.

In S319, the processor may receive data for updating the software associated with the important controller from the first external electronic device. The processor may update the software in a state where the autonomous vehicle is stopped, based on receiving the data for updating the software associated with the important controller from the first external electronic device.

The processor may receive a signal for requesting to update the software associated with the important controller from the first external electronic device. The processor may provide a user with guidance associated with requesting to update the software, based on receiving the signal for requesting to update the software associated with the important controller. For example, the processor may provide the user with the guidance associated with requesting to update the software using an output device including a display included in the autonomous vehicle. The step S319 may be omitted.

As described above, the vehicle control apparatus may help the autonomous vehicle to be operated by recovering (e.g., restoring) the changed software, using the data for recovering the changed software from the first external electronic device, based on that the software associated with the important controller is changed by the second external electronic device.

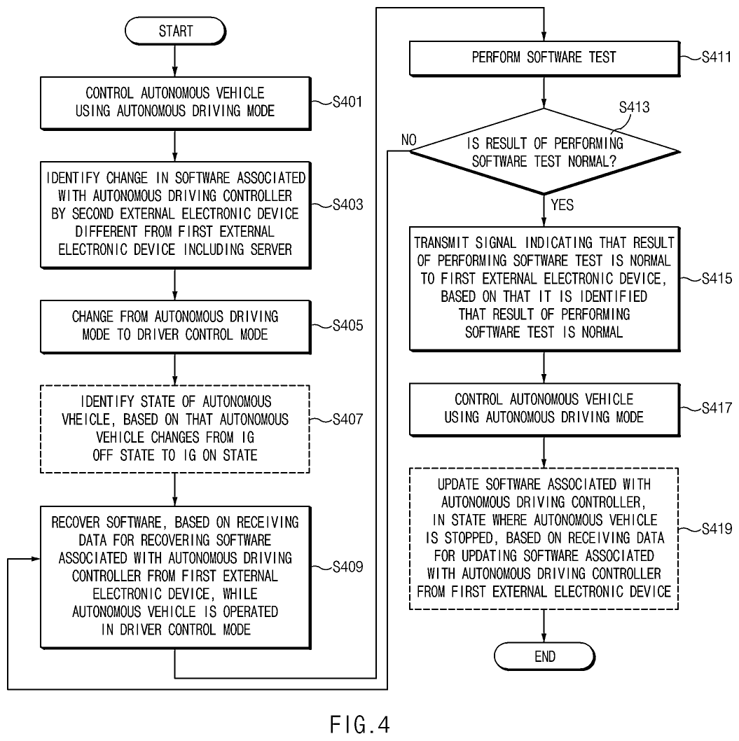

FIG. 4 illustrates an example of a flowchart about an operation of a vehicle control apparatus.

Hereinafter, it is assumed that a vehicle control apparatus 100 of FIG. 1 performs a process of FIG. 4. Furthermore, in a description of FIG. 4, an operation described as being performed by a processor may be understood as being controlled by a processor 110 of a vehicle control apparatus 100.

Respective operations of FIG. 4 may be sequentially performed, but are not necessarily sequentially performed. For example, an order of the respective operations may be changed, and at least two operations may be performed in parallel.

Referring to FIG. 4, in S401, the processor of the autonomous vehicle may control the autonomous vehicle using an autonomous driving mode. S401 may be substantially the same as S301 of FIG. 3 or may include S301.

In S403, the processor may identify a change in software associated with an autonomous driving controller by a second external electronic device different from a first external electronic device including a server.

For example, the software associated with the autonomous driving controller may include an autonomous driving domain including an advanced driver assistance system (ADAS). For example, the ADAS may include at least one of an automotive navigation system, adaptive cruise control (ACC), a lane keeping assist system (LKAS), lane keeping assist (LKA), highway driving assist (HDA), blind spot assist (BSA), blind-spot collision-avoidance assist (BCA), remote smart parking assist (RSPA), driver attention warning (DAW), intelligent speed limit assist (ISLA), a forward collision warning system (FCWS), park assist pilot, or a vehicle communication system, or any combination thereof. However, the present disclosure is not limited thereto.

In S405, the processor may change from the autonomous driving mode to a driver control mode. For example, the processor may change from the autonomous driving mode to the driver control mode, based on identifying that the at least a part of the software associated with the autonomous driving controller.

In S407, the processor may verify a state of the autonomous vehicle, based on that the autonomous vehicle changes from an IG OFF state to an IG ON state. For example, S407 may be substantially the same as S307 of FIG. 3 or may include S307.

In S409, the processor may receive data for recovering the software associated with the autonomous driving controller from the first external electronic device, while the autonomous vehicle is operated in the driver control mode. The processor may recover the software, based on receiving the data for recovering the software associated with the autonomous driving controller from the first external electronic device while the autonomous vehicle is operated in the driver control mode.

The processor may recover the changed software in response to a signal for requesting to recover the software associated with the autonomous driving controller, which is received using an input device (e.g., a display including a touch panel) included in the autonomous vehicle.

In S411, the processor may perform a software test. For example, the software test performed by the processor in S411 may be substantially the same as the software test performed by the processor in S311 of FIG. 3 or may include S311.

In S413, the processor may identify whether the result of performing the software test is normal. For example, S413 may be substantially the same as S313 of FIG. 3 or may include S313.

When the result of performing the software test is normal (YES of S413), in S415, the processor may transmit a signal indicating that the result of performing the software test is normal to the first external electronic device, based on that it is identified that the result of performing the software test is normal.

For example, the processor may transmit a signal indicating that the result of performing the software verification is normal to the first external electronic device, based on that it is identified that the result of performing the software verification is normal.

When the result of performing the software test is not normal (NO of S415), the processor may perform S409. The processor may transmit a signal for requesting data for recovering software to the first external electronic device, based on that it is identified that the result of performing the software test is not normal.

In S417, the processor may control the autonomous vehicle using the autonomous driving mode. For example, the processor may change from the driver control mode to the autonomous driving mode and may control the autonomous vehicle in the autonomous driving mode, based on identifying that the result of performing the software test is normal.

In S419, the processor may receive data for updating the software associated with the autonomous driving controller from the first external electronic device. The processor may update the software associated with the autonomous driving controller, in a state where the autonomous vehicle is stopped, based on receiving the data for updating the software associated with the autonomous driving controller from the first external electronic device.

The processor may receive a signal for requesting to update the software associated with the autonomous driving controller from the first external electronic device. The processor may provide a user with guidance associated with requesting to update the software, based on receiving the signal for requesting to update the software associated with the autonomous driving controller. For example, the processor may provide the user with the guidance associated with requesting to update the software using an output device including a display included in the autonomous vehicle. Step S419 may be omitted.

As described above, the vehicle control apparatus may recover the changed software, using the data for recovering the changed software from the first external electronic device, based on that the software associated with the autonomous driving controller is changed by the second external electronic device, thus helping the autonomous vehicle to be operated in the autonomous driving mode.

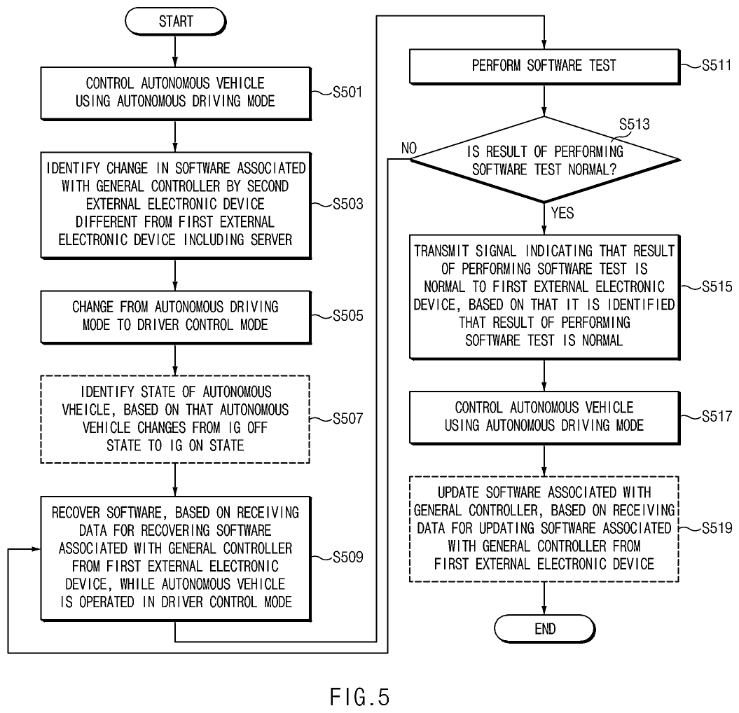

FIG. 5 illustrates an example of a flowchart about an operation of a vehicle control apparatus.

Hereinafter, it is assumed that a vehicle control apparatus 100 of FIG. 1 performs a process of FIG. 5. Furthermore, in a description of FIG. 5, an operation described as being performed by a processor may be understood as being controlled by a processor 110 of a vehicle control apparatus 100.

Respective operations of FIG. 5 may be sequentially performed, but are not necessarily sequentially performed. For example, an order of the respective operations may be changed, and at least two operations may be performed in parallel.

Referring to FIG. 5, in S501, the processor of the autonomous vehicle may control an autonomous vehicle using an autonomous driving mode. S501 may be substantially the same as S301 of FIG. 3 or S401 of FIG. 4 or may include S301 or S401.

In S503, the processor may identify a change in software associated with a general controller by a second external electronic device different from a first external electronic device including a server.

For example, the general controller may include a communication controller for communicating with an external electronic device different from the vehicle control apparatus. For example, the general controller may include an infotainment system for providing infotainment.

In S505, the processor may change from the autonomous driving mode to a driver control mode. For example, the processor may change from the autonomous driving mode to the driver control mode, based on identifying that at least a part of the software associated with the general controller is changed.

In S507, the processor may verify a state of the autonomous vehicle, based on that the autonomous vehicle changes from an IG OFF state to an IG ON state. For example, S507 may be substantially the same as S307 of FIG. 3 or S407 of FIG. 4 or may include S307 or S407.

In S509, the processor may receive data for recovering the software associated with the general controller from the first external electronic device, while the autonomous vehicle is operated in the driver control mode. The processor may recover the software, based on receiving the data for recovering the software associated with the general controller from the first external electronic device while the autonomous vehicle is operated in the driver control mode.

The processor may recover the software associated with the general controller in response to a signal for requesting to recover the software associated with the general controller, which is received using an input device (e.g., a display including a touch panel) included in the autonomous vehicle.

In S511, the processor may perform a software test. For example, the software test performed by the processor in S511 may be substantially the same as the software test performed by the processor in S311 of FIG. 3 or S411 of FIG. 4 or may include S311 or S411.

In S513, the processor may identifier whether the result of performing the software test is normal. For example, S513 may be substantially the same as S313 of FIG. 3 or S413 of FIG. 4 or may include S313 or S413.

When the result of performing the software test is normal (YES of S513), in S515, the processor may transmit a signal indicating that the result of performing the software test is normal to the first external electronic device, based on that it is identified that the result of performing the software test is normal.

For example, the processor may transmit a signal indicating that the result of performing software verification is normal to the first external electronic device, based on that it is identified that the result of performing the software verification is normal.

When the result of performing the software test is not normal (NO of S515), the processor may perform S509. The processor may transmit a signal for requesting data for recovering software to the first external electronic device, based on that it is identified that the result of performing the software test is not normal.

In S517, the processor may control the autonomous vehicle using the autonomous driving mode. For example, the processor may change from the driver control mode to the autonomous driving mode and may control the autonomous vehicle in the autonomous driving mode, based on identifying that result of performing the software test is normal.

In S519, the processor may receive data for updating the software associated with the general controller from the first external electronic device.

For example, the processor may update the software associated with the general controller, in a state where the autonomous vehicle is stopped or operated, based on receiving the data for updating the software associated with the general controller from the first external electronic device.

The processor may receive a signal for requesting to update the software associated with the general controller from the first external electronic device. The processor may provide a user with guidance associated with requesting to update the software, based on receiving the signal for requesting to update the software associated with the general controller. For example, the processor may provide the user with the guidance associated with requesting to update the software using an output device including a display included in the autonomous vehicle. The step S519 may be omitted.

As described above, the vehicle control apparatus may change from the autonomous driving mode to the driver control mode, based on that the software associated with the general controller is changed by the second external electronic device, thus preventing a vehicle accident.

Furthermore, the vehicle control apparatus may recover the software which is associated with the general controller and is changed by the second external electronic device, thus helping the autonomous vehicle to be operated.

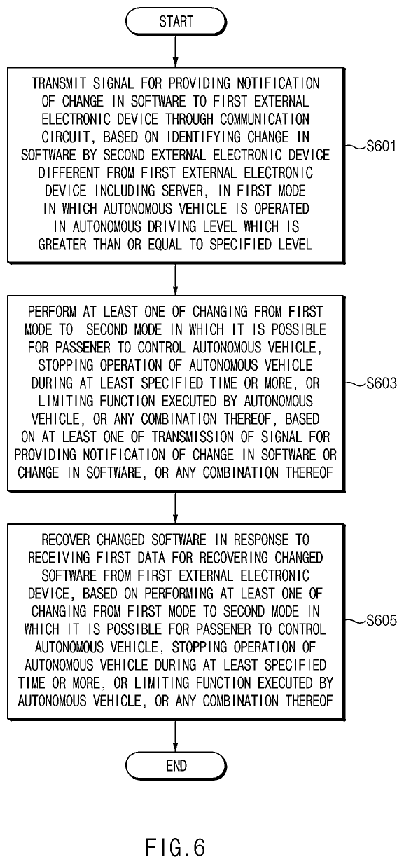

FIG. 6 illustrates an example of a flowchart about an operation of a vehicle control apparatus.

Hereinafter, it is assumed that a vehicle control apparatus 100 of FIG. 1 performs a process of FIG. 6. Furthermore, in a description of FIG. 6, an operation described as being performed by a processor may be understood as being controlled by a processor 110 of a vehicle control apparatus 100.

Respective operations of FIG. 6 may be sequentially performed, but are not necessarily sequentially performed. For example, an order of the respective operations may be changed, and at least two operations may be performed in parallel.

Referring to FIG. 6, in S601, the processor of the vehicle control apparatus may operate an autonomous vehicle in an autonomous driving level which is greater than or equal to a specified level.

The processor may identify a change in software by a second external electronic device different from a first external electronic device including a server, in a first mode in which the autonomous vehicle is operated in the autonomous driving level which is greater than or equal to the specified level. The processor may transmit a signal for providing a notification of the change in software to the first external electronic device through a communication circuit (e.g., a communication circuit 120 of FIG. 1), based on identifying the change in software by the second external electronic device.

For example, the change in software by the second external electronic device may include that at least a part of software for controlling the autonomous vehicle is changed by an external electronic device different from the vehicle control apparatus, which is not allowed access to the vehicle control apparatus.

In S603, the processor may perform at least one of changing from the first mode to a second mode in which it is possible for a passenger to control the autonomous vehicle, stopping the operation of the autonomous vehicle during at least a specified time or more, or limiting a function executed by the autonomous vehicle, or any combination thereof, based on at least one of the transmission of the signal for providing the notification of the change in software or the change in software, or any combination thereof.

For example, the second mode in which it is possible for the passenger to control the autonomous vehicle may be referred to as a driver control mode.

For example, the processor may perform at least one of one of the above-mentioned operations or any combination thereof, depending on a type of the software changed by the second external electronic device.

In S605, the processor may receive first data for recovering the changed software from the first external electronic device, based on performing at least one of changing from the first mode to the second mode in which it is possible for the passenger to control the autonomous vehicle, stopping the operation of the autonomous vehicle during the at least a specified time or more, or limiting the function executed by the autonomous vehicle, or any combination thereof. The processor may recover the changed software in response to receiving the first data.

As described above, the vehicle control apparatus may perform at least one of changing from the first mode to the second mode in which it is possible for the passenger to control the autonomous vehicle, stopping the operation of the autonomous vehicle during the at least the specified time or more, or limiting the function executed by the autonomous vehicle, or any combination thereof, based on identifying the software changed by the second external electronic device, thus preventing a vehicle accident.

Furthermore, the vehicle control apparatus may recover the changed software using the first data transmitted from the first external electronic device to maintain an autonomous driving function, thus helping the autonomous vehicle to safely drive.

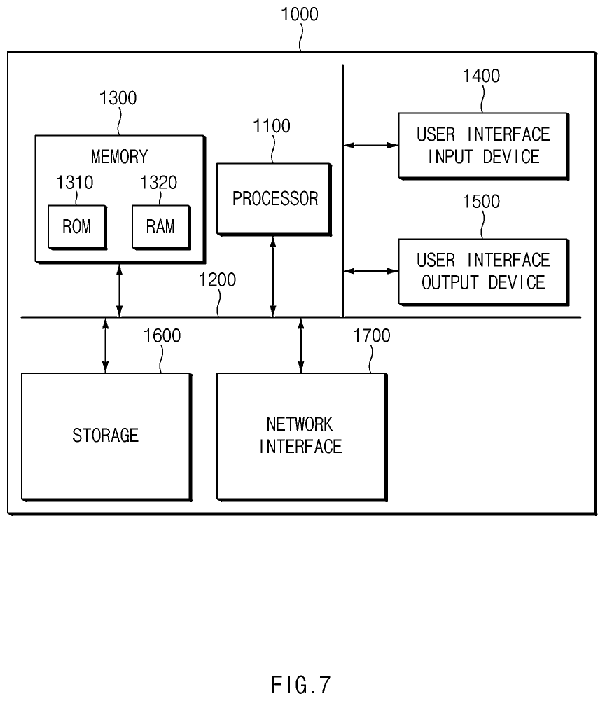

FIG. 7 illustrates a computing system including a vehicle control apparatus.

Referring to FIG. 7, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Accordingly, the operations of the method or algorithm may be directly implemented with a hardware module, a software module, or a combination of the hardware module and the software module, which is executed by the processor 1100. The software module may reside on a storage medium (that is, the memory 1300 and/or the storage 1600) such as a RAM, a flash memory, a ROM, an EPROM, an EEPROM, a register, a hard disc, a removable disk, and a CD-ROM.

The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The present technology may recover software changed by a second external electronic device different from a first external electronic device including a server.

Furthermore, the present technology may recover a system hacked by the second external electronic device.

Furthermore, the present technology may perform a different operation depending on a hacked controller, when one of an important controller, an autonomous driving controller, or a general controller is hacked.

In addition, various effects ascertained directly or indirectly through the present disclosure may be provided.

Hereinabove, although the present disclosure has been described with reference to example embodiment(s) and the accompanying drawings, the present disclosure is not limited thereto, but may be variously modified and altered by those skilled in the art to which the present disclosure pertains without departing from the spirit and scope of the present disclosure claimed in the following claims.

Therefore, example embodiment(s) of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. A vehicle control apparatus, comprising:
a communication circuit;
a processor configured to control an autonomous vehicle; and
memory storing instructions that, when executed by the processor, cause the vehicle control apparatus to:
in a first mode in which the autonomous vehicle is operated in an autonomous driving level greater than or equal to a specified level, transmit, to a first external device via the communication circuit and based on detecting an unauthorized modification to software of the autonomous vehicle by a second external device different from the first external device, a signal indicating the unauthorized modification to the software, wherein the first external device comprises a server;
perform, based on the transmission of the signal, at least one of:
changing from the first mode to a second mode that allows a passenger of the autonomous vehicle to control the autonomous vehicle,
stopping operation of the autonomous vehicle for a specified time duration, or
limiting a function executed by the autonomous vehicle; and
restore the software, based on receiving, from the first external device, first data for restoring the software.

2. The vehicle control apparatus of claim 1, wherein the instructions, when executed by the processor, cause the vehicle control apparatus to:
stop the operation of the autonomous vehicle for the specified time duration or limit the function, based on identifying that the unauthorized modification to the software is associated with at least one of: a powertrain of the autonomous vehicle, a body of the autonomous vehicle, a chassis of the autonomous vehicle, or a communication gateway of the autonomous vehicle, wherein the function is associated with the unauthorized modification.

3. The vehicle control apparatus of claim 1, wherein the instructions, when executed by the processor, cause the vehicle control apparatus to:
change from the first mode to the second mode, based on identifying that the unauthorized modification to the software is associated with at least one of: an autonomous driving feature of the autonomous vehicle or an information feature of the autonomous vehicle.

4. The vehicle control apparatus of claim 1, wherein the first data comprises the software before being modified by the second external device.

5. The vehicle control apparatus of claim 1, wherein the instructions, when executed by the processor, further cause the vehicle control apparatus to:
perform a software test, based on the software being restored; and
transmit, to the first external device via the communication circuit and based on a result of the software test being normal, a signal indicating the result.

6. The vehicle control apparatus of claim 5, wherein the software test comprises at least one of software verification or software validation.

7. The vehicle control apparatus of claim 1, wherein the instructions, when executed by the processor, further cause the vehicle control apparatus to:
receive, from the first external device via the communication circuit, second data; and
update, based on the second data, the restored software.

8. The vehicle control apparatus of claim 7, wherein the instructions, when executed by the processor, cause the vehicle control apparatus to:
update the restored software after the autonomous vehicle is stopped.

9. The vehicle control apparatus of claim 1, wherein the instructions, when executed by the processor, cause the vehicle control apparatus to:
restore the software using the first data, based on a speed of the autonomous vehicle being less than or equal to a specified speed.

10. The vehicle control apparatus of claim 1, wherein the instructions, when executed by the processor, cause the vehicle control apparatus to:
restore the software based on receiving, via an input device of the autonomous vehicle, a request to restore the software.

11. A vehicle control method comprising:
in a first mode in which an autonomous vehicle is operated in an autonomous driving level greater than or equal to a specified level, transmitting, to a first external device and based on detecting an unauthorized modification to software of the autonomous vehicle of by a second external device different from the first external device, a signal indicating the unauthorized modification to the software, wherein the first external device comprises a server;
performing, based on the transmitting of the signal, at least one of:
changing from the first mode to a second mode that allows a passenger of the autonomous vehicle to control the autonomous vehicle,
stopping operation of the autonomous vehicle for a specified time duration, or
limiting a function executed by the autonomous vehicle; and
restoring the software, based on receiving, from the first external device, first data for restoring the software.

12. The vehicle control method of claim 11, wherein the stopping of the operation or limiting of the function is based on identifying that the unauthorized modification to the software is associated with at least one of: a powertrain of the autonomous vehicle, a body of the autonomous vehicle, a chassis of the autonomous vehicle, or a communication gateway of the autonomous vehicle.

13. The vehicle control method of claim 11, wherein the changing from the first mode to the second mode is based on identifying that the unauthorized modification to the software is associated with at least one of: an autonomous driving feature of the autonomous vehicle or information feature of the autonomous vehicle.

14. The vehicle control method of claim 11, wherein the first data comprises the software before being modified by the second external device.

15. The vehicle control method of claim 11, further comprising:
performing a software test, based on the software being restored; and
transmitting, to the first external device and based on a result of the software test being normal, a signal indicating the result.

16. The vehicle control method of claim 15, wherein the software test comprises at least one of software verification or software validation.

17. The vehicle control method of claim 11, further comprising:
receiving, from the first external device, second data; and
updating, based on the second data, the restored software.

18. The vehicle control method of claim 17, wherein the updating of the restored software comprises:
updating the restored software after the autonomous vehicle is stopped.

19. The vehicle control method of claim 11, further comprising:
restoring the software using the first data, based on a speed of the autonomous vehicle being less than or equal to a specified speed.

20. The vehicle control method of claim 11, wherein the restoring of the software comprises:
restoring the software based on receiving, via an input device of the autonomous vehicle, a request to restore the software.
